(19) United States
(12) Patent Application Publication
(10) Pub. No.: US 2012/0127630 A1
(43) Pub. Date: May 24, 2012

(54) Solid State Supercapacitor and Method for Manufacturing the Same

(75) Inventors: Ting-Keng LIN, NEW TAIPEI CITY (TW); Hsin-Guo GONG, New Taipei City (TW); Hung-Chin CHANG, New Taipei City (TW); Li-Hui LIN, New Taipei City (TW)

(73) Assignee: DELIJIOU INDUSTRY & SYSTEMS CO., LTD., New Taipei City (TW)

(21) Appl. No.: 13/278,747

(22) Filed: Oct. 21, 2011

(30) Foreign Application Priority Data
Nov. 19, 2010 (TW) 099139919

(51) Int. Cl. H01G 9/155; H01G 13/00; B05D 5/12; B82Y 40/00; B82Y 30/00; B82Y 99/00

(52) U.S. Cl. 361/502; 427/79; 264/104; 977/762; 977/948; 977/890; 977/893

(57) ABSTRACT

A solid state supercapacitor and a method for manufacturing the same is provided, the solid state supercapacitor including two nanowire electrodes with their surface full of nanowire bundle and a dielectric material filled in a space between the two nanowire bundle electrodes and the nanowire bundle, wherein the nanowire bundle includes many nanowires to increase the surface area of electrodes; since the two nanowire bundle electrodes include the nanowire bundle, the surface area thereof is large; a dielectric layer is the original material of the dielectric material, directly reacted, deposited and cured in the space between the two nanowire bundle electrodes without causing pollutions due to additional processing; therefore, the dielectric layer is of high purity and density and has high permittivity to achieve the greatest permittivity of the dielectric material. As a result, the energy capacity of unit volume of the capacitor is effectively increased.

This application claims the benefits of the Taiwan Patent Application Serial NO. 099139919 filed on Nov. 19, 2010, the subject matter of which is incorporated herein by reference.

### BACKGROUND OF THE INVENTION

1. Field of the Invention

The present invention relates to a solid state supercapacitor, and more particularly to a solid state supercapacitor with a high-purity dielectric material having its highest permittivity, which is done by increasing the surface area of the electrode via nanowire bundles and has the high-purity dielectric material by directly performing a reactive deposition.

2. Description of the Prior Art

A capacitor is an electrical component for storing energy and is utilized for coupling, flitering, tuning, phase-shifting, storing energy, bypassing, etc. Due to the evolution of high frequency power electronics circuits, high energy density has become the trend of development. Although a ceramic capacitor has high permittivity, its permittivity can be further enhanced, there is still a lot deficiencies due to its manufacturing conditions: first, the ceramic material needs to go under a crushing process after calcination, which may cause pollution and decrease the permittivity of the ceramic material; second, binding agents are added into the ceramic material for molding, which lowers the purity of the material and permittivity; third, after sintering, the ceramic material has a smooth surface so it can only be combined with a plane electrode or other electrodes which does not have large surface area, such as a disc capacitor or an MLCC. In terms of MLCC, at present the length and the width of an MLCC are limited for production.

At present, a capacitor manufactured by conventional methods can not have characteristics of large surface area and super high permittivity both, and thus a capacitor having super large unit volume of capacity cannot be manufactured. For instance, although an electrolytic capacitor and an electric double-layer supercapacitor are both conductors having large surface area, the utility of an electrolytic solution prevents a dielectric layer of high permittivity, high durability, high security, and high withstand voltage value, and the working temperature is also limited.

For electrolytic capacitors, an anodic process is performed so that the surface of aluminum foils generates aluminium oxides as an insulation layer. When the polarity is opposite or the voltage is excessive, the insulation layer is damaged and causing a leakage of electricity; further, the electrolytic solution is decomposed and gas is therefore generated; as a result, security problems such as blow-ups of capacitors and systems explosion are caused.

Although electric double-layer capacitors have large surface area for conducting, the utility of aqueous electrolyte in cells results in disadvantages of very low withstand voltage value, very low permittivity, slow response speed, maximum voltage less than 3V, and serial connections are needed to obtain higher voltages, which additionally costs configurations of power management system and causes danger of operation.

An EESU has been disclosed in U.S. Pat. No. 7,033,406 and U.S. Pat. No. 7,466,536, in which a high-permittivity composition-modified barium titanate ceramic powder is utilized as a dielectric material, aluminum oxide and calcium magnesium aluminosilicate are utilized for double-coating the dielectric material, and a screen printing technique is utilized for a symmetric nickel electrode layer. Perform a sintering to the material and a hot isostatic pressing on the material so that an energy storage structure having high densification and large surface area due to thin-film processing is therefore provided.

However, the disadvantages of the prior art lie in: since a thin-film processing is performed, the stress of a mixed slurry is difficult to eliminate. It is also difficult to overcome problems such as the generation of impurities, micro cracks and bubbles. Even if a ceramic glass substrate material is utilized as a matrix, it still indirectly lowers the effective permittivity, generates problems of thermal shocks, impurities, mechanical stresses, etc., and causes problems of internal cracks of the dielectric material. Furthermore, since maximum voltage is not high enough due to the thin-film processing and should be obtained by serial connections, if one layer in the serial connections structure is an open circuit or a short circuit, the entire energy storage unit will fail or the maximum voltage is lowered, which causes security problems. Meanwhile, it is noted that a high purity of composition-modified barium titanate material is utilized and a sintering process of thin-film processing the material is performed in order to increase the entire charge storage capacity; however, although this method increases energy density of the energy storage unit, the maximum energy density cannot be really achieved and the production risk cannot be decreased. It will be very challenging to overcome these defects so this prior art increases costs greatly.

Besides, according to CA2598754 and CA2598787, a pure ceramic material and a ceramic polymer composition material are utilized as a dielectric layer; aluminum and aluminum alloy are utilized as an electrode layer; when manufacturing an internal electrode, a floating electrode which does not connect an external electrode is added; and manufacture the energy storage unit by stacking. However, if the floating electrode having large surface area is not connected to the external electrode, it is just an image electrode and cannot attract polarized electrical charge; that is this method cannot really manufacture a capacitor with high capacity. Moreover, the particle size of the ceramic polymer mixture, the technique of material dispersion process, the effect of dielectric property and the effect of densification are all changes in manufacturing. Also, the polymer is very sensitive to the environmental temperature, which will also affect the densification of the material and the distances of the electrodes; as a result, the temperature rises and the entire module expands, the capacity decreases largely and the energy storage is affected. Furthermore, the floating electrode is too dispersive to control, which easily causes short circuits and therefore is a challenge in manufacturing.

### SUMMARY OF THE INVENTION

The present invention relates to a solid state supercapacitor and a method for manufacturing the same so that an objective of high energy capacity and high energy density is reached.

A solid state supercapacitor is provided, including a first nanowire bundle electrode, a second nanowire bundle electrode and a dielectric material; the first nanowire bundle electrode including a first electrode and a first nanowire bundle, wherein the first nanowire bundle extends vertically from the first electrode and includes a plurality of first nanowires, the first nanowires are separated from each other by a space; the second nanowire bundle electrode including a second electrode and a second nanowire bundle, wherein the second electrode is disposed in parallel to the first electrode and the second nanowire bundle extends vertically from the second electrode, separated from the first nanowire bundle by a space, and including a plurality of second nanowires, the second nanowires are separated from each other by a space; the dielectric material disposed in the spaces among the first nanowires, the spaces among the second nanowires, and the space between the first nanowire bundle electrode and the second nanowire bundle electrode.

According to an embodiment of the present invention, the first electrode and the second electrode are disposed on the same surface of a plate; for example, the first electrode and the second electrode are disposed on the upper surface of the plate. According to another embodiment of the present invention, the first electrode and the second electrode are disposed on different surfaces; for example, the first electrode and the second electrode are respectively disposed on the upper surface and the lower surface of the plate.

Moreover, a method for manufacturing a solid state supercapacitor is further provided, the method including the following steps: (a) forming a first electrode, a second electrode and a plurality of nanopores on a surface of a plate, covering the first electrode and the second electrode with an adhesive; (b) filling the nanopores with an electrode material to form a first nanowire bundle and a second nanowire bundle, the first nanowire bundle separated from the second nanowire bundle by a space, the first nanowire bundle having a plurality of first nanowires and electrically connecting the first electrode to form a first nanowire bundle electrode, the second nanowire bundle having a plurality of second nanowires and electrically connecting the second electrode to form a second nanowire bundle electrode; (c) removing the plate; and (d) filling the spaces among spaces of the first nanowires, spaces of the second nanowires and spaces between the first nanowire bundle electrode and the second nanowire bundle electrode with a dielectric material.

According to an embodiment of the present invention, the first electrode and the second electrode are disposed on the same surface of the plate; for example, the first electrode and the second electrode are disposed on the upper surface of the plate. According to another embodiment of the present invention, the first electrode and the second electrode are disposed on different surfaces; for example, the first electrode and the second electrode are respectively disposed on the upper surface and the lower surface of the plate.

Compared with a capacitor in prior art, the solid state supercapacitor of the present invention has characteristics of high power density and high energy density. The withstand voltage value is adjustable by the width of the space between two nanowire bundle electrodes. Therefore, the solid state supercapacitor of the present invention is applicable to DC power storages of various voltages and AC power equipments.

Since a dielectric layer of the present invention is generated by directly performing a reactive deposition without other additional processing, no other pollutions will be caused. Therefore, after curing (or sintering, or drying), the dielectric layer is of high purity and high densification and also has high permittivity. Meanwhile, since the surface of the electrode is nanowire bundle, the surface area of the electrode is very large, and thus the capacity of the solid state supercapacitor is increased.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a stereogram showing a solid state supercapacitor according to an embodiment of the present invention;

FIG. 2A is a top view of a plate of an embodiment of the present invention;

FIG. 2B is a sectional view of a plate of an embodiment of the present invention;

FIG. 3A is a top view of an electrode pattern formed on a plate of an embodiment of the present invention;

FIG. 3B is a sectional view of an electrode pattern formed on a plate of an embodiment of the present invention;

FIG. 4A is a top view showing forming nanopores and covering with an adhesive according to an embodiment of the present invention;

FIG. 4B is a sectional view showing forming nanopores and covering with an adhesive according to an embodiment of the present invention;

FIG. 5A is a top view showing removing a plate after a nanowire bundle is formed according to an embodiment of the present invention;

FIG. 5B is a sectional view and an enlarged drawing, the sectional view showing removing a plate after a nanowire bundle is formed and the enlarged drawing showing the nanowire bundle according to an embodiment of the present invention;

FIG. 6A is a top view showing filling spaces with a dielectric material according to an embodiment of the present invention;

FIG. 6B is a sectional view and an enlarged drawing, the sectional view showing filling spaces with a dielectric material and the enlarged drawing showing a nanowire bundle according to an embodiment of the present invention;

FIG. 7A is a top view showing removing an adhesive according to an embodiment of the present invention;

FIG. 7B is a sectional view showing removing an adhesive according to an embodiment of the present invention; and

FIG. 8 is a stereogram showing a solid state supercapacitor according to another embodiment of the present invention.

### DETAILED DESCRIPTION OF THE PREFERRED EMBODIMENT

The present invention relates to a solid state supercapacitor, and more particularly to a solid state supercapacitor with a high-purity dielectric material having its highest permittivity, which is done by increasing the surface area of the electrode via nanowire bundles and has the high-purity dielectric material by directly performing a reactive deposition. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

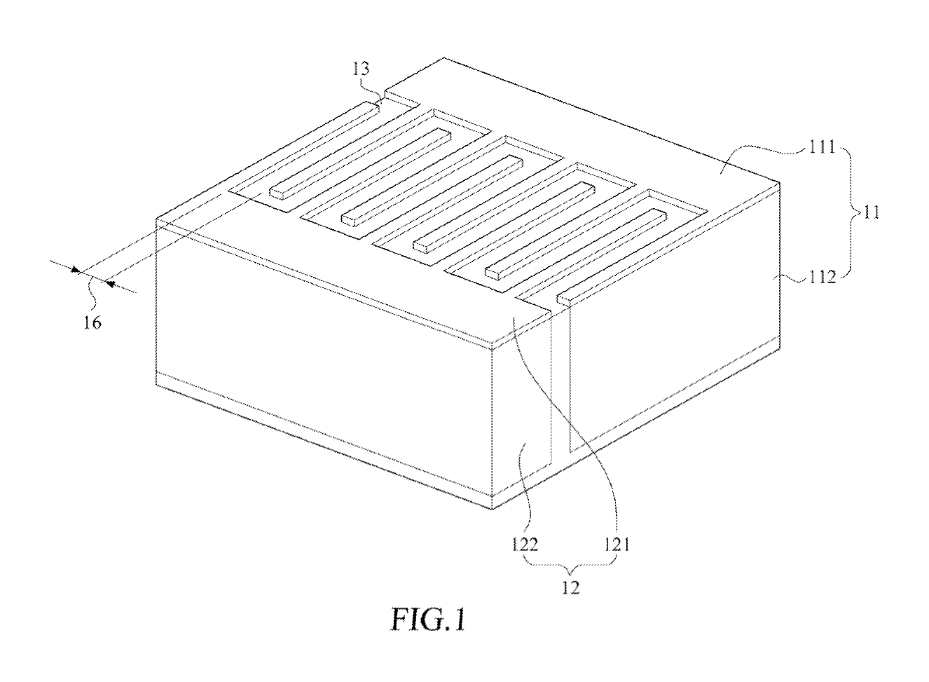

Referring to FIG. 1, FIG. 1 is a stereogram showing a solid state supercapacitor according to an embodiment of the present invention. The solid state supercapacitor includes a first nanowire bundle electrode 11, a second nanowire bundle electrode 12 and a dielectric material 13.

The first nanowire bundle electrode 11 includes a first electrode 111 and a first nanowire bundle 112, wherein the first nanowire bundle 112 extends vertically from the first electrode 111 and includes a plurality of first nanowires, the first nanowires are separated from each other by a space; the second nanowire bundle electrode 12 includes a second electrode 121 and a second nanowire bundle 122, wherein the second nanowire bundle 122 extends vertically from the second electrode 121, separated from the first nanowire bundle 112 by a space, and including a plurality of second nanowires, the second nanowires are separated from each other by a space.

The second electrode 121 is disposed in parallel to the first electrode 111. According to an embodiment of the present invention, when the first electrode 111 and the second electrode 121 are disposed on the same surface, the first nanowire bundle 112 and the second nanowire bundle 122 extend toward the same direction. According to another embodiment of the present invention, when the first electrode 111 and the second electrode 121 are disposed on different surfaces, the first nanowire bundle 112 extends toward the second electrode 121 and the second nanowire bundle 122 extends toward the first electrode 111.

The dielectric material 13 is disposed in the spaces among the first nanowires, the spaces among the second nanowires, and a space 16 between the first nanowire bundle electrode 11 and the second nanowire bundle electrode 12. Various permittivity materials are adopted according to various properties of product; according to an embodiment of the present invention, the dielectric material 13 includes barium titanate (BaTiO₃).

A method for manufacturing a solid state supercapacitor is further provided, the method including the following steps.

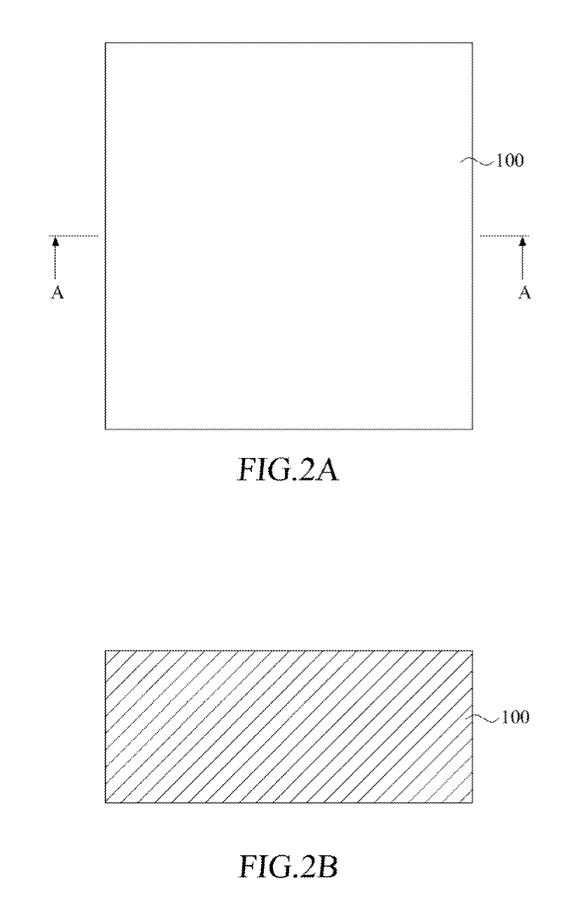

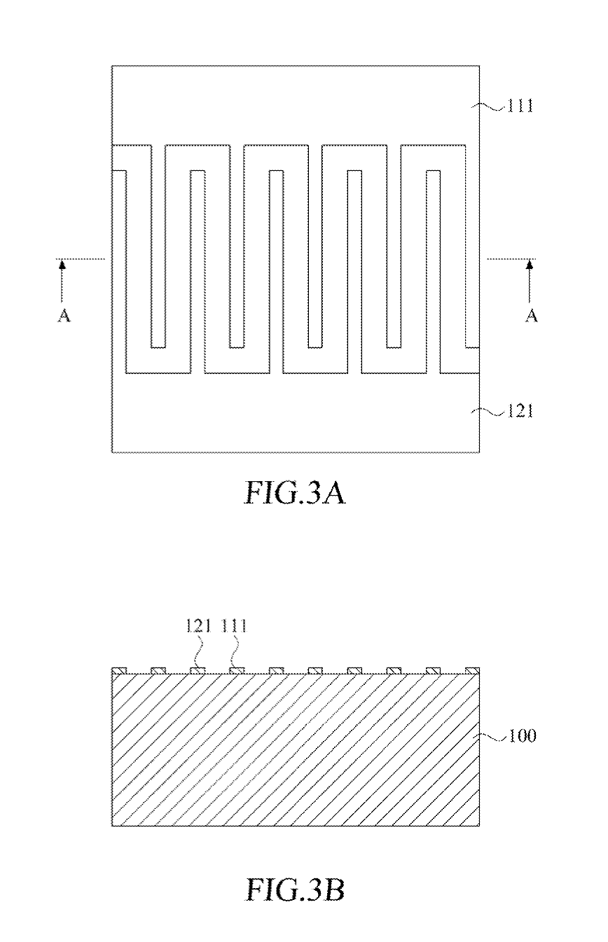

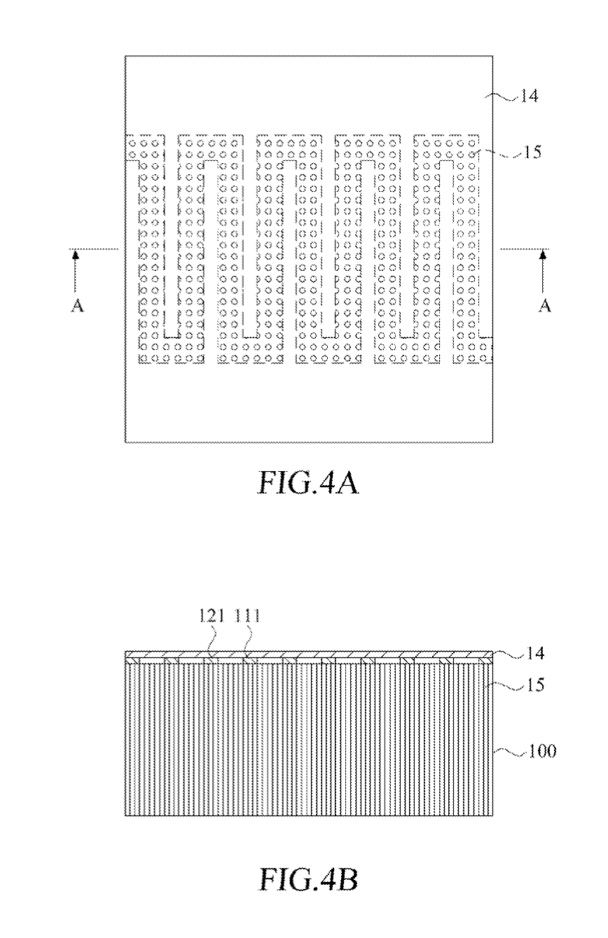

Referring to FIGS. 2A, 2B, 3A, 3B, 4A and 4B, FIG. 2A is a top view of a plate of an embodiment of the present invention; FIG. 2B is a sectional view of a plate of an embodiment of the present invention; FIG. 3A is a top view of an electrode pattern formed on a plate of an embodiment of the present invention; FIG. 3B is a sectional view of an electrode pattern formed on a plate of an embodiment of the present invention; FIG. 4A is a top view showing forming nanopores and covering with an adhesive according to an embodiment of the present invention; FIG. 4B is a sectional view showing forming nanopores and covering with an adhesive according to an embodiment of the present invention; the sectional views are views crossing along an A-A lines. Firstly, form a first electrode 111, a second electrode 121 and a plurality of nanopores 15 on a surface of a plate 100 and cover the first electrode 111 and the second electrode 121 with an adhesive 14. However, it is important to know that the order of the above step does not affect the follow steps of manufacturing: as it is shown in FIGS. 2 to 4, the step can be firstly forming the first electrode 111 and the second electrode 121 on the plate 100, then forming the nanopores 15 and then covering with the adhesive 14; or, the step can be firstly forming the nanopores 15 on the plate 100, then forming the first electrode 111 and the second electrode 121, and then covering with the adhesive 14. Moreover, a process of forming the nanopores 15 is selected from different methods such as placing the plate 100 in an electrolyte and performing an anodic treatment to form the nanopores 15 on the plate 100.

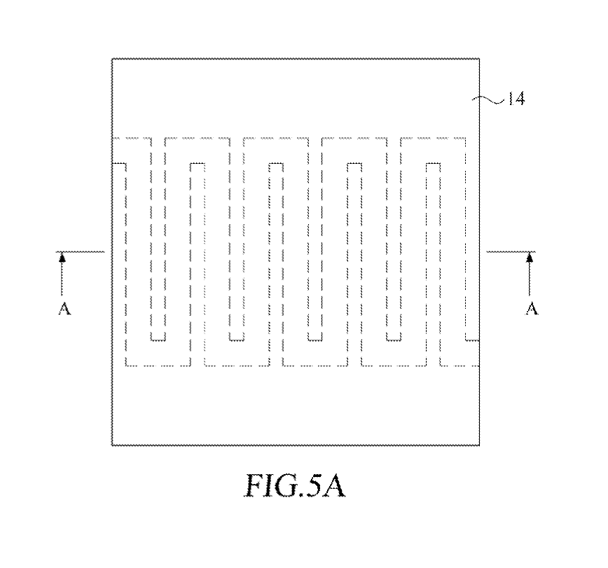

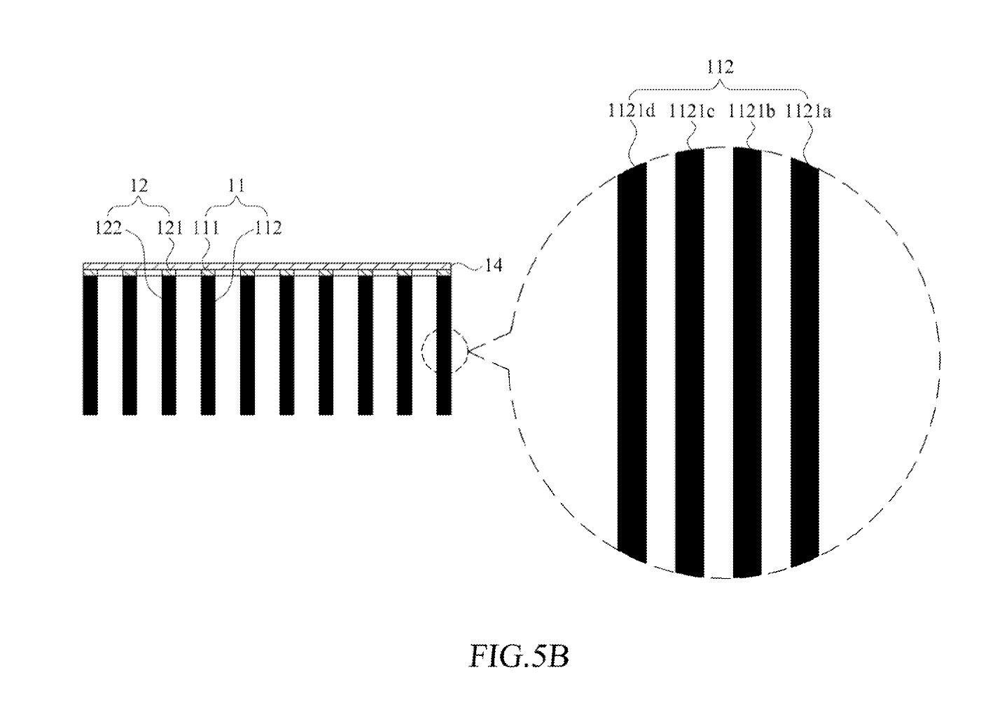

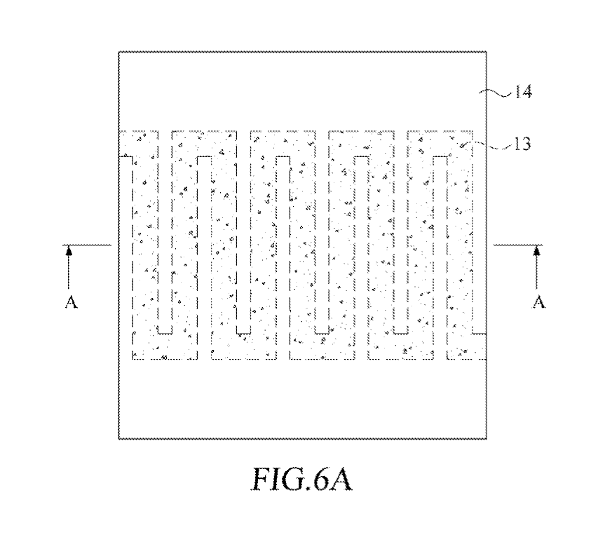

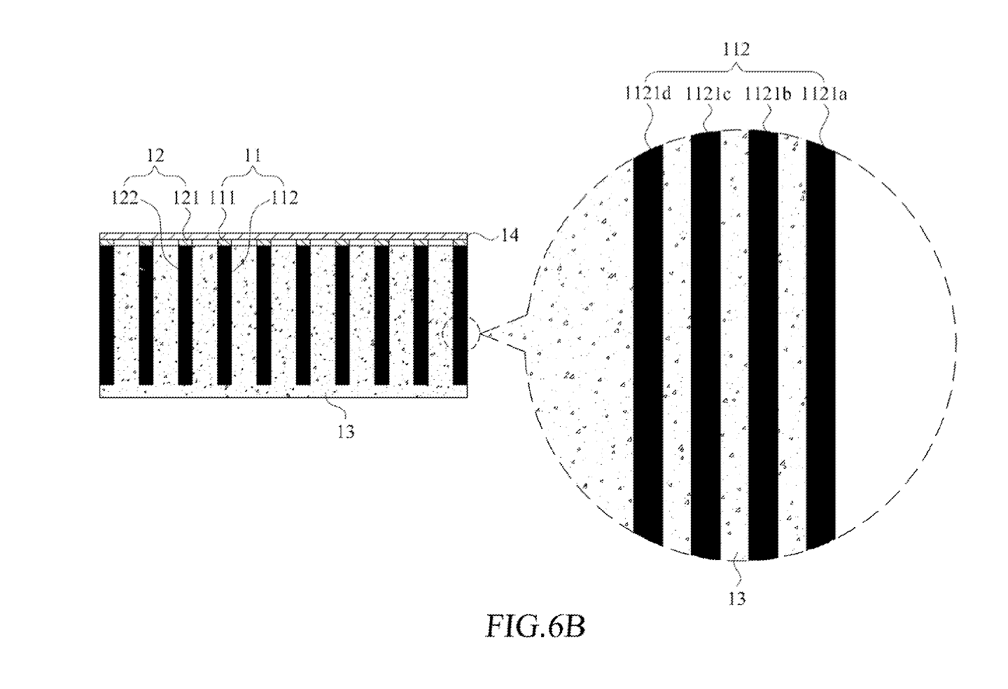

Referring to FIGS. 5A, 5B, 6A and 6B, FIG. 5A is a top view showing removing a plate after a nanowire bundle is formed according to an embodiment of the present invention; FIG. 5B is a sectional view and an enlarged drawing, the sectional view showing removing a plate after a nanowire bundle is formed and the enlarged drawing showing the nanowire bundle according to an embodiment of the present invention; FIG. 6A is a top view showing filling spaces with a dielectric material according to an embodiment of the present invention; FIG. 6B is a sectional view and an enlarged drawing, the sectional view showing filling spaces with a dielectric material and the enlarged drawing showing a nanowire bundle according to an embodiment of the present invention. Secondly, fill the nanopores 15 with an electrode material to form a first nanowire bundle 112 and a second nanowire bundle 122, the first nanowire bundle 112 separated from the second nanowire bundle 122 by a space, the first nanowire bundle 112 electrically connecting the first electrode 111 to form a first nanowire bundle electrode 11, the second nanowire bundle 122 electrically connecting the second electrode 121 to form a second nanowire bundle electrode 12; removing the plate 100 after forming the first nanowire bundle 112 and the second nanowire bundle 122. According to the enlarged drawings, the first nanowire bundle 112 includes a plurality of first nanowires 1121a, 1121b, 1121c and 1121d. Although four first nanowires 1121a, 1121b, 1121c and 1121d are showed in the embodiment of the present invention, it should be understood that changes in the numbers of first nanowires 1121a, 1121b, 1121c and 1121d does not departing from the spirit and scope of the present invention. Accordingly, the second nanowire bundle 122 includes a plurality of second nanowires. According to an embodiment of the present invention, methods of removing the plate 100 include etching and dissolution.

Next, fill the spaces among spaces of the first nanowires 1121a, 1121b, 1121c and 1121d, spaces of the second nanowires and spaces between the first nanowire bundle electrode 11 and the second nanowire bundle electrode 12 with a dielectric material 13. The dielectric material 13 includes materials which have dielectric properties such as ceramics or vacuum status; curing part of the dielectric material 13 may be required after filling; for example, when the dielectric material 13 includes ceramics, methods of forming the dielectric material 13 are selected from the group of sintering, curing and drying. Curing is a common technique in prior art and therefore is not further described here.

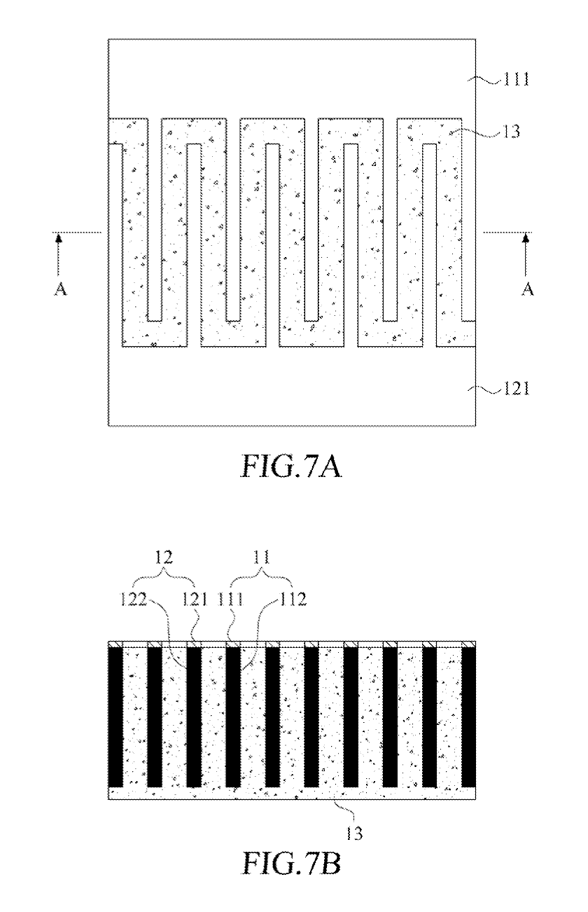

Referring to FIGS. 7A and 7B, FIG. 7A is a top view showing removing an adhesive according to an embodiment of the present invention; FIG. 7B is a sectional view showing removing an adhesive according to an embodiment of the present invention. Finally, a suitable method of curing the dielectric material 13 according to its properties and remove the adhesive 14 to manufacture the solid state supercapacitor of the present invention. Methods of removing the adhesive include: when the dielectric material 13 includes ceramics, remove the adhesive 14 at the same time of sintering.

According to embodiments of the present invention, electrical parallel connections are made by stacking up the solid state supercapacitor toward one direction so as to meet different requirements of electric capacities.

Moreover, according to embodiments of the present invention, working voltages of the solid state supercapacitor are adjustable by adjusting the width of the space 16 between the first nanowire bundle electrode 11 and the second nanowire bundle electrode 12.

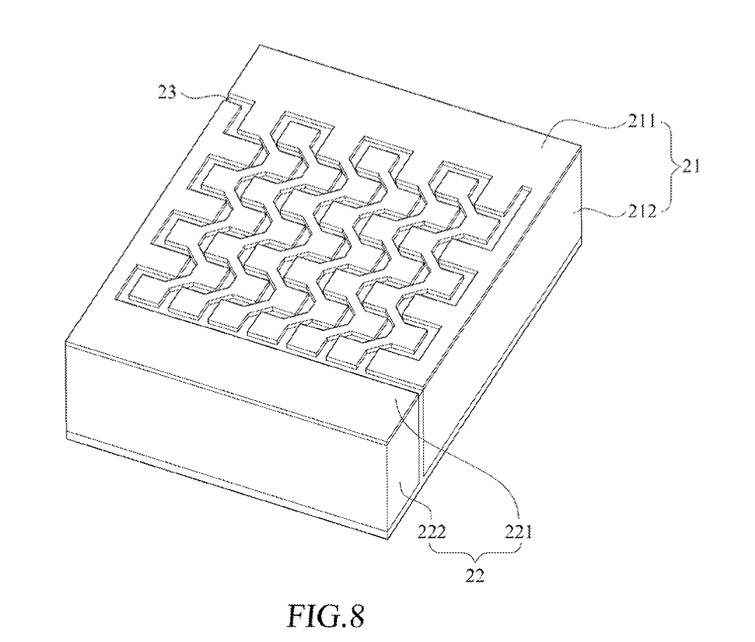

Further, referring to FIG. 8, FIG. 8 is a stereogram showing a solid state supercapacitor according to another embodiment of the present invention. When manufacturing the solid state supercapacitor, a first nanowire bundle electrode 21 and a second nanowire bundle electrode 22 are designed in various shapes such as a zigzag shape or an interdigitated shape under the circumstances of a first nanowire bundle 212 and a second nanowire bundle 222 electrically connecting to a first electrode 211 and a second electrode 221 respectively and being separated from each other by a space and a dielectric material 23 filling in the space.

A further method for manufacturing a solid state supercapacitor is further provided. The difference between the method and the previous one is that after forming the first nanowire bundle electrode 11 and the second nanowire bundle electrode 12, directly perform a dielectric process on the plate 100 so that the plate 100 is formed as a dielectric material 13, wherein the dielectric process is selected from the group of sintering, curing and drying; moreover, before performing a dielectric process on the plate 100, performing a hybrid sedimentation of the plate 100 with at least a metal solution.

For example, when the material of the plate 100 includes TiO₂, after forming the first nanowire bundle electrode 11 and the second nanowire bundle electrode 12, perform a hybrid sedimentation by putting the plate 100 into a solution of Ba(OH)₂; after the barium ions in the solution of Ba(OH)₂ entering the nanopores 15 of the plate 100, perform a dielectric process selected from the group of sintering, curing and drying on the plate 100 so that the property of the plate 100 is transformed from TiO₂ into BaTiO₃, which is a very good dielectric material.

In conclusion, the electrodes of the solid state supercapacitor of the present invention connect to nanowire bundles having larger surface area. Since the capacity value of a capacitor is in direct proportion to the area of an electrode and permittivity, and is in inverse proportion to the distance between electrodes, a ceramic dielectric layer which has enlarged areas of electrodes and high permittivity can effectively increase the capacity value. By adjusting the width of the space between the first nanowire bundle electrode and the second nanowire bundle electrode, the working voltage is changed; moreover, by stacking the solid state supercapacitor in parallel to obtain needed capacity, and thereby a specification requirement of high voltage and high energy density is met.

While the present invention has been particularly shown and described with reference to a preferred embodiment, it will be understood by those skilled in the art that various changes in form and detail may be without departing from the spirit and scope of the present invention.

What is claimed is:

1. A solid state supercapacitor comprising:
a first nanowire bundle electrode including a first electrode and a first nanowire bundle, the first nanowire bundle extending vertically from the first electrode and including a plurality of first nanowires, wherein the first nanowires are separated from each other by a space;
a second nanowire bundle electrode including a second electrode and a second nanowire bundle, the second electrode disposed in parallel to the first electrode, the second nanowire bundle extending vertically from the second electrode, separated from the first nanowire bundle by a space, and including a plurality of second nanowires, wherein the second nanowires are separated from each other by a space; and
a dielectric material disposed in the spaces among the first nanowires, the spaces among the second nanowires, and the space between the first nanowire bundle electrode and the second nanowire bundle electrode.

2. A method for manufacturing a solid state supercapacitor, the method comprising following steps:
(a) forming a first electrode, a second electrode and a plurality of nanopores on a surface of a plate, covering the first electrode and the second electrode with an adhesive;
(b) filling the nanopores with an electrode material to form a first nanowire bundle and a second nanowire bundle, the first nanowire bundle separated from the second nanowire bundle by a space, the first nanowire bundle having a plurality of first nanowires and electrically connecting the first electrode to form a first nanowire bundle electrode, the second nanowire bundle having a plurality of second nanowires and electrically connecting the second electrode to form a second nanowire bundle electrode;
(c) removing the plate; and
(d) filling the spaces among spaces of the first nanowires, spaces of the second nanowires and spaces between the first nanowire bundle electrode and the second nanowire bundle electrode with a dielectric material.

3. The method of claim 2, wherein the first electrode and the second electrode are respectively disposed on an upper surface and a lower surface of the plate.

4. The method of claim 2, wherein the first electrode and the second electrode are disposed on a surface of the plate.

5. A method for manufacturing a solid state supercapacitor, the method comprising following steps:
(a) forming a first electrode, a second electrode and a plurality of nanopores on a surface of a plate, covering the first electrode and the second electrode with an adhesive;
(b) filling the nanopores with an electrode material to form a first nanowire bundle and a second nanowire bundle, the first nanowire bundle separated from the second nanowire bundle by a space, the first nanowire bundle having a plurality of first nanowires and electrically connecting the first electrode to form a first nanowire bundle electrode, the second nanowire bundle having a plurality of second nanowires and electrically connecting the second electrode to form a second nanowire bundle electrode; and
(c) performing a dielectric process on the plate so that the plate is formed as a dielectric material.

6. The method of claim 5, wherein the dielectric process is selected from the group of sintering, curing and drying.

7. The method of claim 5, further comprising a step of performing a hybrid sedimentation of the plate with at least a metal solution before performing step (c).
